(19) United States
(12) Patent Application Publication
(10) Pub. No.: US 2012/0026263 A1
(43) Pub. Date: Feb. 2, 2012

(54) IMAGE FORMING APPARATUS

(75) Inventor: Yuhei CHIWATA, Kanagawa (JP)

(73) Assignee: FUJIFILM CORPORATION, Tokyo (JP)

(21) Appl. No.: 13/190,494

(22) Filed: Jul. 26, 2011

(30) Foreign Application Priority Data
Jul. 29, 2010 (JP) 2010-170693

(51) Int. Cl. B41J 2/01; B65H 3/08

(52) U.S. Cl. 347/101; 271/97

(57) ABSTRACT

An image forming apparatus is provided which can effectively adapt stacked sheets of paper to the surrounding environment. A controller controls a moving member to move a position at which air is blown to an end portion of a sheet bundle in up and down direction of sheets of paper being stacked. The driving of an air blower is controlled so that the air volume when air is blown toward the lower-side end portion of the sheet bundle by the air blower is larger than the air volume when air is blown toward the upper-side end portion of the sheet bundle. By moving the position at which air is blown by the air blower in the up and down direction, it is possible to effectively adapt the stacked sheet bundle to the surrounding environment, compared with a case where air is simultaneously blown to the entire sheet bundle.

### CROSS-REFERENCE TO RELATED APPLICATION

This application claims priority under 35 USC 119 from Japanese Patent Application No. 2010-170693 filed Jul. 29, 2010, the disclosure of which is incorporated by reference herein.

### BACKGROUND OF THE INVENTION

1. Field of the Invention

The present invention relates to an image forming apparatus.

2. Related Art

Japanese Patent Application Laid-Open No. 2000-118840 discloses a blanking plate on which image-formed sheets of paper discharged from an image forming apparatus or the like are stacked. In a case in which a predetermined number of sheets of paper are stacked on the blanking plate, another blocking plate is stacked on the stacked sheets of paper so as not to press the stacked sheets, thereby suppressing an image formed on a sheet of paper from being transferred to another sheet of paper.

In the related art, since image-formed sheets of paper are sequentially stacked, it is considered that the sheets of paper come in close contact with each other and thus the sheets of paper are not adapted to the surrounding environment.

### SUMMARY OF THE INVENTION

The present invention is to effectively adapt stacked sheets of paper to the surrounding environment (perform seasoning) and to stabilize the posture of the stacked sheets of paper.

According to a first aspect of the invention, there is provided an image forming apparatus including: an image forming apparatus main body that ejects ink droplets onto a sheet of paper to form an image; and a seasoning device that is disposed in a discharge unit to which the sheet of paper having an image formed thereon by the image forming apparatus main body is discharged, wherein the seasoning device includes a separation section that separates stacked sheets of paper on which images are formed into a sheet bundle, an air blowing member that blows air toward an end portion of the sheet bundle separated by the separation section, and a moving member that moves a position at which the air is blown to the end portion of the sheet bundle by the air blowing member in an up and down direction in which the sheets of paper are stacked.

According to this configuration, the separation member separates (makes) the stacked sheets of paper image being formed into the sheet bundle. The air blowing member blows air to an end portion of the sheet bundle separated (made) by the separation member so as to blow the air between the stacked sheets of paper. The moving member moves the position at which the air is blown to the end portion of the sheet bundle by the air blowing member in an up and down direction in which the sheets of paper are stacked.

In this way, by moving the position at which the air is blown in the up and down direction, it is possible to effectively adapt the stacked sheets of paper to the surrounding environment and to stabilize the posture of the stacked sheets, compared with the case in which air is simultaneously blown to all of the stacked sheets of paper.

A second aspect of the invention provides the image forming apparatus according to the first aspect, in the aspect, the apparatus further includes a first controller that controls an air volume of the air blowing member, and the first controller sets the air volume of the air blowing member when the air is blown toward the end portion at a lower side of the sheet bundle to be larger than the air volume of the air blowing member when the air is blown toward the end portion at an upper side of the sheet bundle.

According to this configuration, the first controller sets the air volume (quantity) of the air blowing member when the air is blown to the lower side end portion of the sheet bundle to be larger than the air volume of the air blowing member when the air is blown to the upper side end portion of the sheet bundle. Accordingly, it is possible to efficiently blow air to the sheets of paper on the lower side to which the weight of the sheets of paper of the upper side is loaded and thus to effectively adapt the sheet bundle to the surrounding environment.

A third aspect of the invention provides the image forming apparatus according to the first aspect, in the aspect, the apparatus further includes a second controller that controls an air pressure of the air blowing member, and the second controller sets the air pressure of the air blowing member when the air is blown toward the end portion at a lower side of the sheet bundle to be higher than the air pressure of the air blowing member when the air is blown toward the end portion at an upper side of the sheet bundle.

According to this configuration, the second controller sets the air pressure of the air blowing member when the air is blown to the lower side end portion of the sheet bundle to be larger than the air pressure of the air blowing member when the air is blown to the upper side end portion of the sheet bundle. Accordingly, it is possible to efficiently blow air to the sheets of paper on the lower side to which the weight of the sheets of paper of the upper side is loaded and thus to effectively adapt the sheet bundle to the surrounding environment.

A fourth aspect of the invention provides the image forming apparatus according to the third aspect, in the aspect, an air nozzle of the air blowing member is a variable air nozzle, of which an opening area is variable, and the second controller changes the air pressure of the air nozzle by changing the opening area of the variable air nozzle.

According to this configuration, the second controller changes the air pressure of the air nozzle by changing the opening area of the variable air nozzle of the air blowing member. In this way, it is possible to change the air pressure of the air blowing member with a simple structure.

A fifth aspect of the invention provides the image forming apparatus according to the third or fourth aspect, in the aspect, the second controller controls the moving member such that a moving speed at which the position at which the air is blown is moved in the up and down direction is set so that the moving speed, at a time when the position is moving on the end portion at the lower side of the sheet bundle, is slower than the moving speed, at a time when the position is moving on the end portion at the upper side of the sheet bundle.

According to this configuration, the second controller controls the moving member such that a moving speed at which the position at which the air is blown is moved in the up and down direction is set so that the moving speed, at a time when the position is moving on the end portion at the lower side of the sheet bundle, is slower than the moving speed, at a time when the position is moving on the end portion at the upper side of the sheet bundle. Accordingly, it is possible to efficiently blow air to the sheets of paper on the lower side to which the weight of the sheets of paper of the upper side is loaded and thus to effectively adapt the sheet bundle to the surrounding environment.

A sixth aspect of the invention provides the image forming apparatus according to any one of the first to fifth aspects, in the aspect, the apparatus further includes a temperature and humidity adjusting unit that adjusts temperature and humidity, and the air blowing member blows normal-temperature and normal-humidity air adjusted by the temperature and humidity adjusting unit to the end portion of the sheet bundle.

According to this configuration, the air blowing member blows normal-temperature and normal-humidity air adjusted by the temperature and humidity adjusting unit to the end portion of the sheet bundle. Accordingly, it is possible to suppress the deformation of the sheets, for example, compared with the case in which warm air is blown.

A seventh aspect of the invention provides the image forming apparatus according to any one of the first to sixth aspects, in the aspect, the air pressure of the air blowing member is set to a static pressure which is equal to or greater than 500 Pa.

According to this configuration, the air pressure of the air blowing member is set to a static pressure which is equal to or greater than 500 Pa. Accordingly, it is possible to satisfactorily blow air between the sheets of paper overcoming the pressure loss between the sheets of paper (it is possible to improve the air blowing efficiency).

An eighth aspect of the invention provides the image forming apparatus according to any one of the first to seventh aspects, in the aspect, the separation section is curved in a convex shape toward the upper side as viewed from an air blowing direction of the air blowing member.

According to this configuration, the separation member is curved in a convex shape toward upper side as viewed in the air blowing direction of the air blowing member. Accordingly, if the curl of the sheets of paper is strong, it is possible to regulate the sheet plane of the sheet end portion in the air blowing direction to be parallel to the air blowing direction, thereby stabilizing the ventilation between sheets of paper.

A ninth aspect of the invention provides the image forming apparatus according to any one of the first to seventh aspects, in the aspect the separation section is curved in a convex shape toward the lower side as viewed from an air blowing direction of the air blowing member.

According to this configuration, the separation member is curved in a convex shape toward lower side (in a concave shape) as viewed in the air blowing direction of the air blowing member. Accordingly, when the curl of the sheets of paper is strong, it is possible to regulate the sheet plane of the sheet end portion in the air blowing direction to be parallel to the air blowing direction, thereby stabilizing the ventilation between sheets of paper.

According to the above-mentioned configurations of the invention, it is possible to effectively adapt the stacked sheets of paper to the surrounding environment and to stabilize the posture of the stacked sheets.

### BRIEF DESCRIPTION OF THE DRAWINGS

Embodiments of the invention will be described in detail with reference to the following drawings, wherein:

FIG. 1 is a side view illustrating a seasoning device according to a first embodiment of the invention;

FIG. 2 is a front view illustrating the seasoning device according to the first embodiment of the invention;

FIG. 3 is a plan view illustrating the seasoning device according to the first embodiment of the invention;

FIG. 4 is a side view illustrating the seasoning device according to the first embodiment of the invention;

FIG. 5 is a perspective view illustrating a housing and the like used in the seasoning device according to the first embodiment of the invention;

FIG. 6 is a diagram schematically illustrating an image forming apparatus used for the seasoning device according to the first embodiment of the invention; and

FIGS. 7A and 7B are perspective views illustrating an air blower and the like used in a seasoning device according to a second embodiment of the invention.

### DETAILED DESCRIPTION OF THE INVENTION

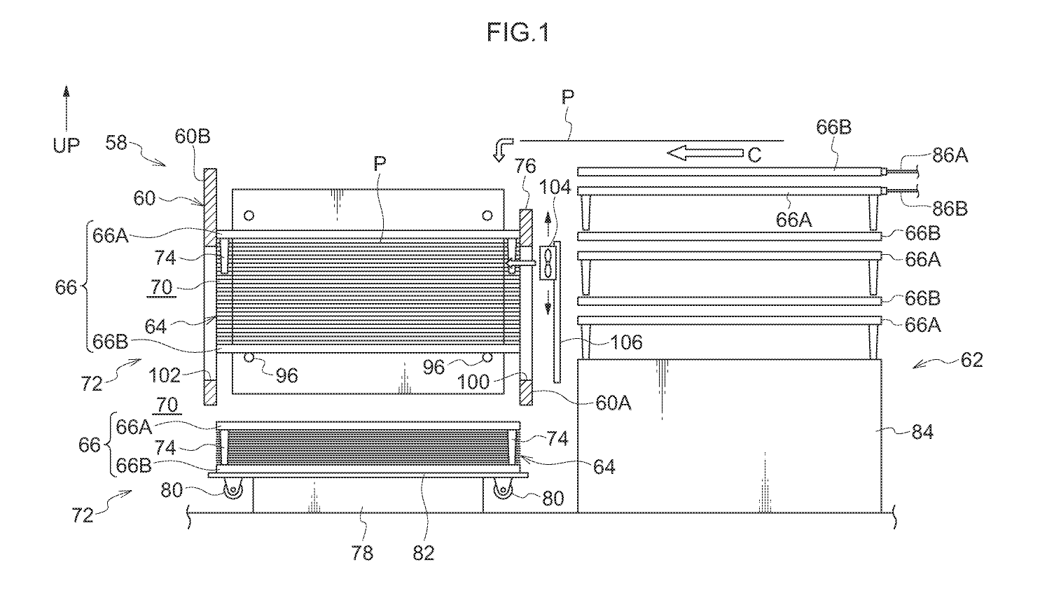

A seasoning device 58 and an image forming apparatus 10 according to a first embodiment of the invention will be described below with reference to FIGS. 1 to 6. Arrow UP in the drawings represents an upside in a vertical direction.

Entire Configuration

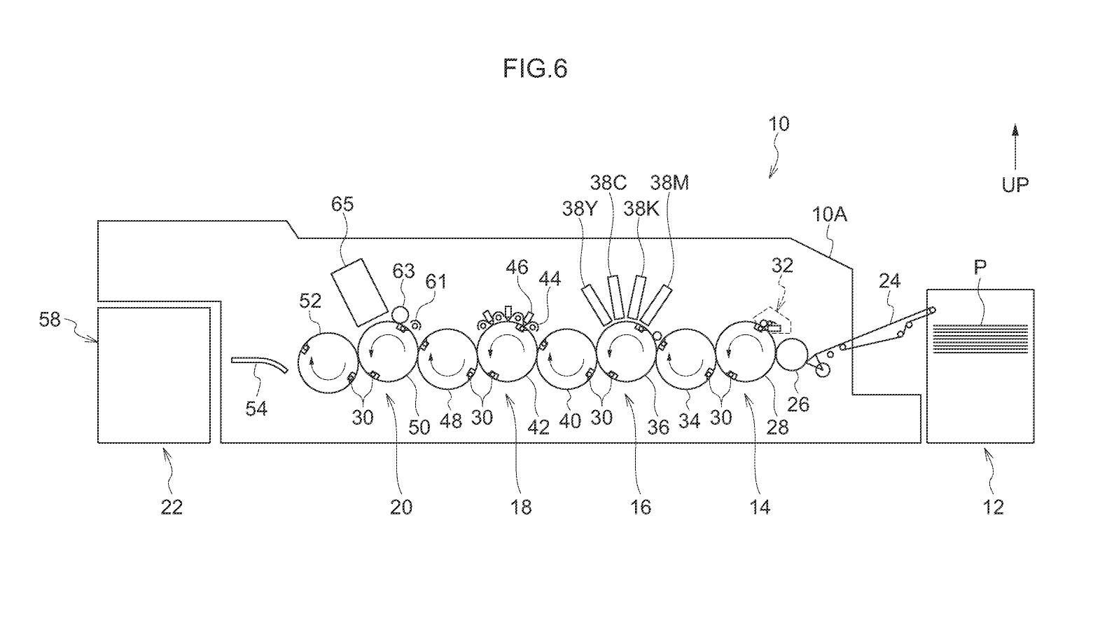

As shown in FIG. 6, an image forming apparatus 10 includes a paper feed unit 12 that feeds a sheet of paper P as a recording medium to an apparatus body 10A, a process liquid applying unit 14 that applies a process liquid to an image forming surface of the sheet of paper P, an image forming unit 16 that forms an image on the sheet of paper P, a drying unit 18 that reduces the moisture of (dries) the sheet of paper P so as to enhance strength of image layer of an image-formed portion in which an image is formed, a fixing unit 20 that fixes the formed image to the sheet of paper P, and a discharge unit 22 to which the sheet of paper P is discharged.

The sheets of paper P are stacked on the paper feed unit 12 and the sheets of paper P are sent out to the apparatus body 10A by the paper feed unit 12 sheet by sheet. A feed tray 24 guiding the sheet of paper P sent out from the paper feed unit 12 to the apparatus body 10A is disposed downstream side in the transporting direction of the sheet of paper P (hereinafter, simply referred to as “downstream side”) with respect to the paper feed unit 12. A feed drum 26 rotating and transporting the sheet of paper P along the outer circumferential surface thereof is disposed in the apparatus body 10A downstream side with respect to the feed tray 24. The sheet of paper P is transported to the process liquid applying unit 14 by the feed drum 26.

The process liquid applying unit 14 includes a process liquid applying drum 28, with rotating, receiving the sheet of paper P transported by the feed drum 26 and transporting the sheet of paper P along the outer circumferential surface thereof. Specifically, a holding member 30 holding the end of the sheet of paper P is disposed on the outer circumferential surface of the process liquid applying drum 28. According to this configuration, the sheet of paper P is transported downstream side by means of the rotation of the process liquid applying drum 28 in the state in which the end of the sheet of paper P is held by the holding member 30.

A process liquid applying device 32 applying the process liquid to the image forming surface of the sheet of paper P transported by the process liquid applying drum 28 is disposed above the process liquid applying drum 28. The process liquid has an effect of reacting with liquid droplets to be described later to aggregate a coloring material (pigment) and to promote the separation of the coloring material (pigment) from the solvent.

A transporting drum 34, with rotating, receiving the sheet of paper P transported by the process liquid applying drum 28 and transporting the sheet of paper P to the image forming unit 16 is disposed downstream side with respect to the process liquid applying drum 28.

The image forming unit 16 includes an image forming drum 36, with rotating, receiving the sheet of paper P transported by the transporting drum 34 and transporting the sheet of paper P along the outer circumferential surface thereof. A liquid droplet ejecting head 38 ejecting liquid droplets of ink or the like to the sheet of paper P transported by the image forming drum 36 to form an image on the sheet of paper P is disposed above the image forming drum 36. The liquid droplet ejecting head 38 is a so-called full-line head having an ink ejecting range corresponding to the maximum width of the sheet of paper P. In this embodiment, the liquid droplet ejecting heads 38 of four colors of Y (Yellow), M (Magenta), C (Cyan), and K (Black) as exemplary basic colors are arranged in the circumferential direction of the image forming drum 36.

A transporting drum 40 receiving the sheet of paper P transported by the image forming drum 36 and transporting the sheet of paper P to the drying unit 18 is disposed downstream side with respect to the image forming drum 36.

The drying unit 18 includes a drying drum 42, with rotating, receiving the sheet of paper P transported by the transporting drum 40 and transporting the sheet of paper P along the outer circumferential surface thereof. A halogen heater 44 and a warm air nozzle 46 as an example of a drying member are disposed above the drying drum 42. While the sheet of paper P is being transported by the drying drum 42, the moisture contained in the sheet of paper P is reduced (dried) by means of the heat from the halogen heater 44 and the warm air from the warm air nozzle 46 so as to enhance the strength of image layer of the image-formed portion in which an image is formed. Accordingly, the strength of image layer of the image formed on the sheet of paper P is improved.

A transporting drum 48 receiving the sheet of paper P transported by the drying drum 42 and transporting the sheet of paper P to the fixing unit 20 is disposed downstream side with respect to the drying drum 42.

The fixing unit 20 includes a fixing drum 50, with rotating, receiving the sheet of paper P transported by the transporting drum 48 and transporting the sheet of paper P along the outer circumferential surface thereof. A halogen heater 61 for heating (preliminary heating), a fixing roller 63 pressing the sheet of paper P against the fixing drum 50, and an in-line sensor 65 measuring a check pattern, an amount of moisture, a surface temperature, a gloss level, and the like of the sheet of paper P are disposed to face the outer circumferential surface of the fixing drum 50.

A discharge drum 52, with rotating, receiving the sheet of paper P transported by the fixing drum 50 and discharging the received sheet of paper P to the outside of the apparatus body 10A is disposed downstream side with respect to the fixing drum 50.

A guide plate 54 formed in a curved shape so as to guide the sheet of paper P to the outside of the apparatus body 10A is disposed downstream side with respect to the discharge drum 52.

The sheet of paper P discharged to the outside of the apparatus body 10A is discharged to a seasoning device 58 disposed in the discharge unit 22 by the discharge drum 52. The details of the seasoning device 58 will be described later.

Main Configuration

As shown in FIG. 1, the seasoning device 58 includes a housing 60 having a box shape of which the bottom is opened and a blanking device 62 disposed adjacent to the housing 60.

A separation plate section 66 as an example of the separation member separating the sheets of paper P into a sheet bundle 64 is disposed in the housing 60. The separation plate section 66 is configured to include an upper separation plate 66A disposed above the sheet bundle 64 and a lower separation plate 66B on which the sheet bundle 64 is placed.

That is, a predetermined number of (for example, 300 to 500) sheets of paper P are stacked and supported on the lower separation plate 66B to form the sheet bundle 64 and the upper separation plate 66A is disposed above the sheet bundle 64. That is, the sheet bundle 64 is housed in a sheet bundle housing space 70 formed between the lower separation plate 66B and the upper separation plate 66A. Hereinafter, the sheet bundle 64, the lower separation plate 66B which is at the lower of the sheet bundle 64, and the upper separation plate 66A which is at the upper of the sheet bundle 64 together is called a sheet bundle unit 72.

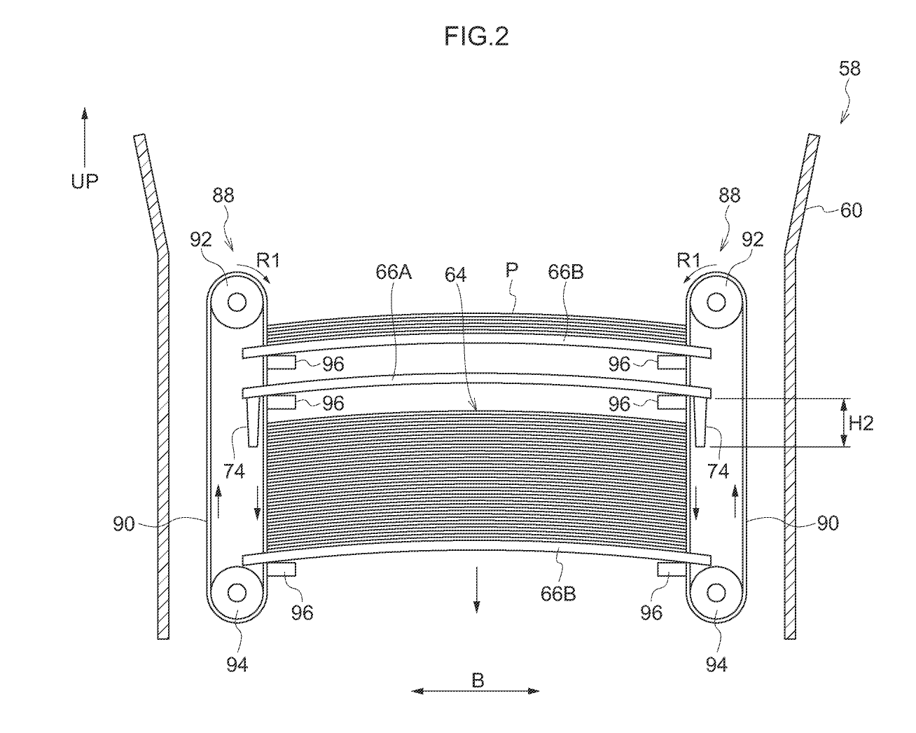

As shown in FIG. 2, the upper separation plate 66A and the lower separation plate 66B has a shape in which the center portion in a width direction (the direction of arrow B shown in FIG. 2, which is simply referred to as a width direction) as viewed in an air blowing direction of an air blower 104 as an example of the air blowing member to be described later is raised and both end portions in the width direction are lowered, that is, an upwardly-convex shape (arch shape).

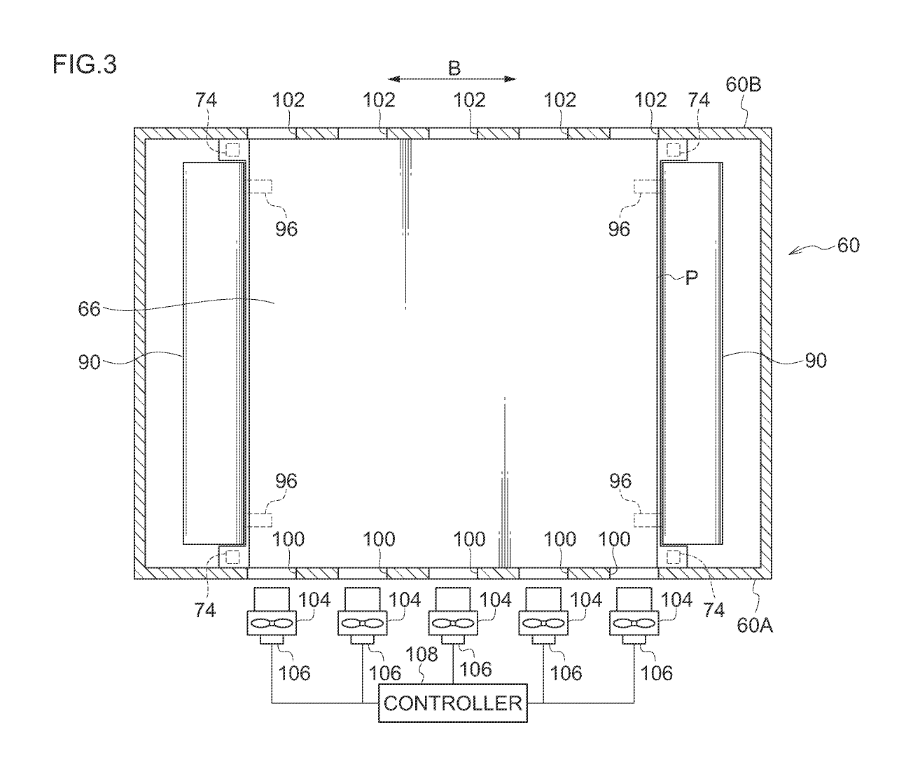

As shown in FIGS. 2 and 3, four corners of the upper separation plate 66A protrude in the width direction (protruding portions), and spacers 74 protruding toward the lower separation plate 66B from the bottom surfaces of the protruding portions are provided. The spacers 74 have a predetermined height H2 so that even when the lower end portion of the spacer 74 comes in contact with the top surface of the lower separation plate 66B, a predetermined gap for housing the sheet bundle 64 is guaranteed (ensured) between the lower separation plate 66B and the upper separation plate 66A, as described later.

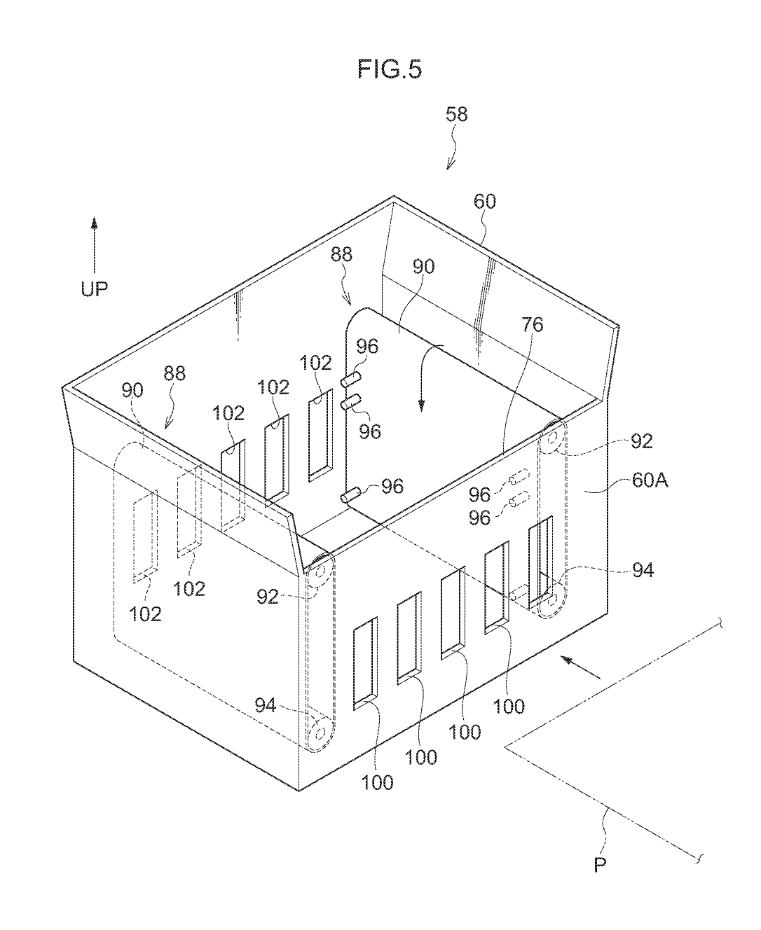

As shown in FIG. 5, the housing 60 has a box shape of which the bottom is opened. A front side plate 60A of the housing 60, which is disposed on the side from which the separation plate section 66 and the sheets of paper P are input to the inside of the housing 60, is lower in the up and down direction than the other side plates, so as to form an input concave portion 76 in the housing 60.

As shown in FIG. 1, a pallet support 78 on which the separation plate section 66 (the sheet bundle unit 72) housing the sheet bundle 64 therein is placed is disposed below the housing 60. Specifically, a pallet 82 having casters 80 is supported on the pallet support 78 and the sheet bundle unit 72 having been subjected to the seasoning (performing of the seasoning is finished) to be described later is placed on the top surface of the pallet 82.

On the other hand, the blanking device 62 inputting the separation plate sections 66 to the inside of the housing 60 includes a separation plate support 84 on which the separation plate sections 66 including the upper separation plate 66A and the lower separation plate 66B are placed. The lower separation plates 66B and the upper separation plates 66A are alternately placed on the separation plate support 84. The separation plate support 84 goes up and down so that the uppermost separation plate section 66 (two plates, that is, the lower separation plate 66B and the upper separation plate 66A) is located at a height corresponding to the input concave portion 76 of the housing 60.

The blanking device 62 includes input rods 86A and 86B pressing the end portions of the uppermost separation plate section 66 (end portions of the lower separation plate 66B and the upper separation plate 66A) in the direction of arrow C and inputting the separation plate section 66 to the inside of the housing 60 through the input concave portion 76. The blanking device 62 includes a guide member not shown in the drawings so as to prevent the careless inclination or dropping of the separation plate section 66 and to smoothly input the separation plate section 66 to the inside of the housing 60.

As shown in FIG. 5, a pair of separation plate lowering devices 88 supporting and lowering the input separation plate section 66 are disposed on the inner surface of the housing 60.

Each separation plate lowering device 88 includes an endless lowering belt 90 and a driving pulley 92 and a driven pulley 94 that are disposed in lined up manner in the up and down direction and on which the lowering belt 90 is wound. Support pieces supporting the separation plate section 66 are arranged vertically at a constant interval on the outer circumferential surface of the lower belt 90. Specifically, the support pieces 96 support the side portions of the separation plate section 66 (the side portions of the lower separation plate 66B and the side portions of the upper separation plate 66A) input to the inside of the housing 60.

Here, the relative position in the up and down direction of the support pieces 96 are set so that the spacer 74 do not contact with the lower separation plate 66B in a state in which the lower separation plate 66B and the upper separation plate 66A are supported by the support pieces 96.

The driving pulley 92 is connected to a driving shaft (not shown in the drawings) and is rotationally driven in the direction of arrow R1 (see FIG. 2) by the use of a driving motor (not shown in the drawings). By means of this rotational driving, the lowering belt 90 is circulated and moved and the lower separation plate 66B and the upper separation plate 66A are lowered at a constant lowering speed while maintaining a predetermined gap therebetween.

At this time, the lowering-amount (lowering speed) is set depending on the increasing speed in height of the sheets of paper P by the sequential housing of the sheets of paper P in the housing 60.

On the other hand, as shown in FIGS. 1, 3 and 5, six openings 100 extending in the up and down direction are formed in the front side plate 60A, disposed on the side from which the sheets of paper P are input, of the housing 60, and six openings 102 extending in the up and down direction to face the openings 100 are formed in a rear side plate 60B facing the front side plate 60A. Six blowers 104 blowing air to the end portion of the sheet bundle 64 housed in the housing 60 through the openings 100 are disposed.

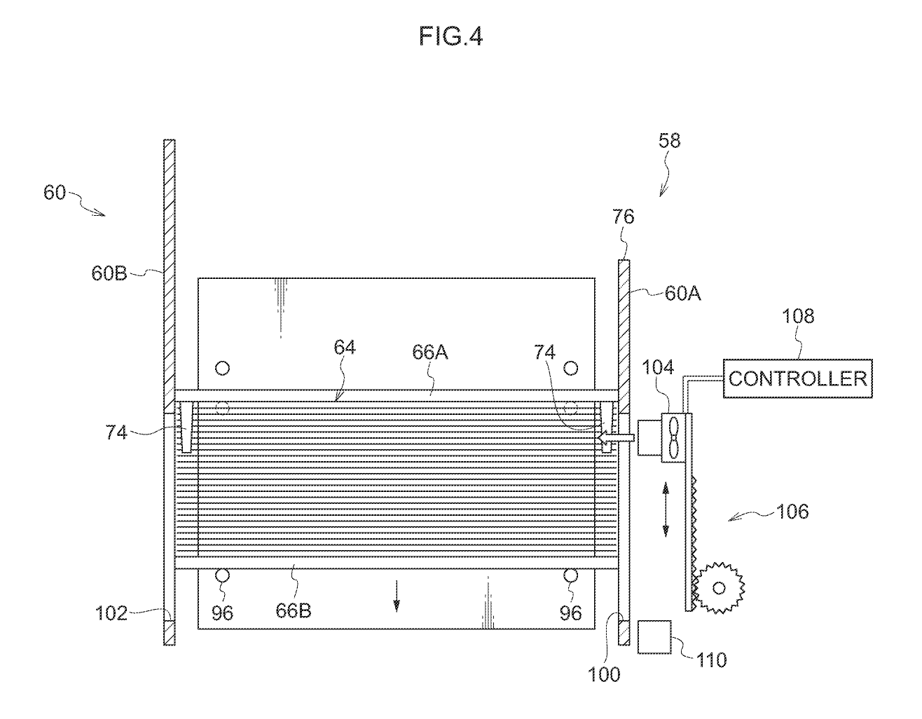

Moving members 106 as an example of the moving member (see FIG. 4) moving the six blowers 104 along the openings 100 extending in the up and down direction are disposed.

A first controller 108 (see FIG. 3) controlling the air blowers 104 and the moving members 106 are provided. The first control unit 108 controls the driving of the air blowers 104 so that the air volume (quantity) by which air is blown to the lower end portion of the sheet bundle 64 by the air blowers 104 is larger than the air volume by which air is blown to the upper end portion of the sheet bundle 64.

As shown in FIGS. 2 and 3, in the state in which the separation plate section 66 is input to the inside of the housing 60 and the sheets of paper P are placed on the lower separation plate 66B, both end sides facing in the width direction of the sheets of paper P go along the outer circumferential surfaces of the lowering belts 90 and both end sides facing in the depth direction of the sheets of paper P go along the front side plate 60A and the rear side plate 60B. That is, the lowering belts 90, the front side plate 60A, and the rear side plate 60B have an air-leakage preventing guiding function. Accordingly, the air blown from the air blowers 104 is blown between the sheets of paper P of the sheet bundle 64 through the openings 100 formed in the front side plate 60A and is discharged to the outside through the openings 102 formed in the rear side plate 60B.

A temperature and humidity adjusting unit 110 (see FIG. 4) adjusting the temperature and the humidity of the wind (air) blown to the sheets of paper P by the air blowers 104 is provided so that normal-temperature and normal-humidity air (having a constant temperature in the range of 5° C. to 35° C. and a constant humidity in the range of 45% RH to 85% RH) is blown to the end portion of the sheet bundle 64.

Operation and Effect

As shown in FIG. 6, the sheet of paper P fed from the paper feed unit 12 is transported along the outer circumferential surfaces of the rotating feed drum 26 and the rotating process liquid applying drum 28. In the process liquid applying unit 14, the process liquid applying device 32 applies a process liquid to the image forming surface of the sheet of paper P transported along the outer circumferential surface of the process liquid applying drum 28.

The sheet of paper P to which the process liquid has been applied is sent to the transporting drum 34 and is transported along the outer circumferential surfaces of the rotating transporting drum 34 and the rotating image forming drum 36. In the image forming unit 16, the liquid droplet ejecting heads 38 of the respective colors eject the liquid droplets of ink or the like to the image forming surface of the sheet of paper P transported by the image forming drum 36 to form an image on the sheet of paper P.

The sheet of paper P having an image formed on the image forming surface thereof is sent to the transporting drum 40 and is transported along the outer circumferential surfaces of the rotating transporting drum 40 and the rotating drying drum 42. In the drying unit 18, the sheet of paper P transported by the drying drum 42 is dried by means of the heat from the halogen heater 44 and the warm air blown from the warm air nozzle 46. That is, the moisture contained in the sheet of paper P is reduced (dried), thereby enhancing the strength of image layer of the image-formed portion in which the image has been formed.

The sheet of paper P which is made to be to a high temperature by means of the heat from the halogen heater 44 and the warm air blown from the warm air nozzle 46 is sent to the transporting drum 48 and is transported along the outer circumferential surfaces of the rotating transporting drum 48 and the rotating fixing drum 50. In the fixing unit 20, the halogen heater 61 disposed to face the fixing drum 50 fixes the image formed on the sheet of paper P onto the sheet of paper P by means of heat. The sheet of paper P transported by the fixing drum 50 is pressed against the fixing drum 50 by the fixing roller 63 and passes through the portion facing the in-line sensor 65. The in-line sensor 65 measures a check pattern, an amount of moisture, a surface temperature, a gloss level, and the like of the sheet of paper P passing therethrough.

The sheet of paper P having been subjected to the measurement by the in-line sensor 65 is sent to the discharge drum 52, is transported along the outer circumferential surface of the rotating discharge drum 52, is guided by the guide plate 54, and is discharged to the discharge unit 22 outside the apparatus body 10A.

In this embodiment, the printing speed is 2700 rph and thus images are formed on 2700 sheets per hour.

As shown in FIG. 1, the sheet of paper P discharged to the discharge unit 22 passes through the upper portion of the blanking device 62, passes through the input concave portion 76, and is stacked on the top surface of the lower separation plate 66B disposed in the housing 60.

As shown in FIG. 2, the lowering belt 90 is circulated by means of the driving power of the driving pulley 92, and the lower separation plate 66B that is supported by the support pieces 96 and on which the sheets of paper P having an image formed thereon are sequentially stacked is lowered.

At a time in which a predetermined number of (for example, 300 to 500) sheets of paper P are stacked as the sheet bundle 64 on the lower separation plate 66B, as shown in FIG. 1, the input rods 86A and 86B input the upper separation plate 66A and the lower separation plate 66B placed on the separation plate support 84 to the inside of the housing 60.

Accordingly, the input upper separation plate 66A is disposed above the lower separation plate 66B on which the sheet bundle 64 is placed. The first controller 108 drives the six blowers 104. The air flow formed by the driving of the air blowers 104 is blown between the sheets of paper P of the sheet bundle 64 disposed between the lower separation plate 66B and the upper separation plate 66A through the openings 100 formed in the front side plate 60A. The air blown between the sheets of paper P is discharged to the outside through the openings 102 formed in the rear side plate 60B. In this way, the air is made to pass between the sheets of paper P, thereby adapting the sheets of paper P to the surrounding environment (performing seasoning). Here, in the embodiment, “performing seasoning” is, concretely, to adjust moisture content of the sheets of paper P (between the sheets of paper P), and the seasoning device 58 is a device to performing seasoning.

As shown in FIG. 4, the controller 108 controls the moving member 106 to move the position at which the air is blown to the end portion of the sheet bundle 64 in the up and down direction in which the sheets of paper are stacked. The controller 108 controls the driving of the air blowers 104 so that the air volume when the air is blown to the lower side end portion of the sheet bundle 64 by the air blowers 104 is larger than the air volume when the air is blown to the upper side end portion of the sheet bundle 64 by the air blowers 104. The sheet bundle 64 is lowered while being subject to seasoning by means of the circulating movement of the lowering belts 90. The controller 108 lowers the up and down movement range of the air blowers 104 according to (corresponding to) the lowering movement of the sheet bundle. The up and down moving period (cycle) is preferably in the range of 1 second to 60 seconds.

When the lowering belt 90 is further circulated, the lower separation plate 66B on which the sheet bundle 64 is placed is released from the supporting of the support pieces 96 and the lower separation plate 66B is placed on the top surface of the pallet 82. The upper separation plate 66A released from the supporting of the support pieces 96 is disposed so as to cover the sheet bundle 64 from the upside of the placed lower separation plate 66B.

Here, by bringing the spacers 74 provided at the upper separation plate 66A into contact with the top surface of the lower separation plate 66B, the weight of the upper separation plate 66A is prevented from being loaded onto the sheet bundle 64. Then, the sheet bundle unit 72 having been subjected to the seasoning (performing of the seasoning has been finished) is transported by the pallet 82 and is moved to a storage space. By repeating the above-mentioned processes, the plural sheet bundle units 72 having been subjected to the seasoning are transported by the pallet 82 and are moved to a storage space.

As described above, by moving the position at which air is blown by the air blowers 104 in the up and down direction, it is possible to effectively adapt the stacked sheet bundle 64 to the surrounding environment (perform seasoning), compared with the case in which air is simultaneously blown to the entire sheet bundle (in which the position at which air is blown is not moved in the up and down direction).

By moving the position at which air is blown by the air blowers 104 in the up and down direction, it is possible to increase the number of sheets of paper which can be simultaneously processed (subject to seasoning), compared with the case in which air is simultaneously blown to the entire sheet bundle.

By moving the position at which air is blown by the air blowers 104 in the up and down direction, it is possible to stabilizer the posture (attitude) of the stacked sheets of paper P, compared with the case in which air is simultaneously blown to the entire sheet bundle.

The first controller 108 sets the air volume of the air blower 104 when the air is blown to the lower side end portion of the sheet bundle 64 to be larger than the air volume of the air blower 104 when the air is blown to the upper side end portion of the sheet bundle 64. Accordingly, it is possible to efficiently blow the air to the lower side sheets of paper P on which the weight of the upper side sheets of paper P is loaded, thereby effectively adapting the sheet bundle 64 to the surrounding environment.

The first controller 108 sets the air volume of the air blower 104 when the air is blown to the lower side end portion of the sheet bundle 64 to be larger than the air volume of the air blower 104 when the air is blown to the upper side end portion of the sheet bundle 64. Accordingly, it is possible to reduce the air volume blown to the upper side sheets of paper P on which the weight of the sheets of paper P is not loaded, thereby stabilizing the posture of the sheets of paper P.

Since the air blowers 104 blow the normal-temperature and normal-humidity air adjusted by the temperature and humidity adjusting unit 110 to the end portion of the sheet bundle 64, it is possible to suppress the deformation of the sheets of paper P, compared with the case in which warm air or compressed air is blown. That is, since the image-non-formed portion (white background) is further dried with the warm air, so it is difficult to alleviate the deformation of the sheets. Since the air blowing efficiency between the sheets of paper P may be improved with the compressed air (of 10 kPa or more) but the air in a compressor is dehumidified to become dry air, the image-non-formed portion (white background) is further dried, whereby it is difficult to alleviate the deformation of the sheets of paper P.

The lower separation plate 66B is curved in a convex shape toward upper side as viewed from the air blowing direction from the air blowers 104. Accordingly, even when the curl of the sheets of paper P is strong, it is possible to regulate the sheet plane at the sheet end portion in the air blowing direction to be parallel to the air blowing direction, thereby stabilizing ventilation between the sheets of paper P.

In the state in which the sheets of paper P are stacked on the lower separation plate 66B, both end portions, facing in the width direction, of the sheets of paper P go along the outer circumferential surfaces of the lowering belts 90, and both end portions, facing in the depth direction, of the sheets of paper P go along the front side plate 60A and the rear side plate 60B. Accordingly, it is possible to suppress the air blown from the air blowers 104 from leaking to an unintended portion, thereby effectively adapting the sheet bundle 64 to the surrounding environment.

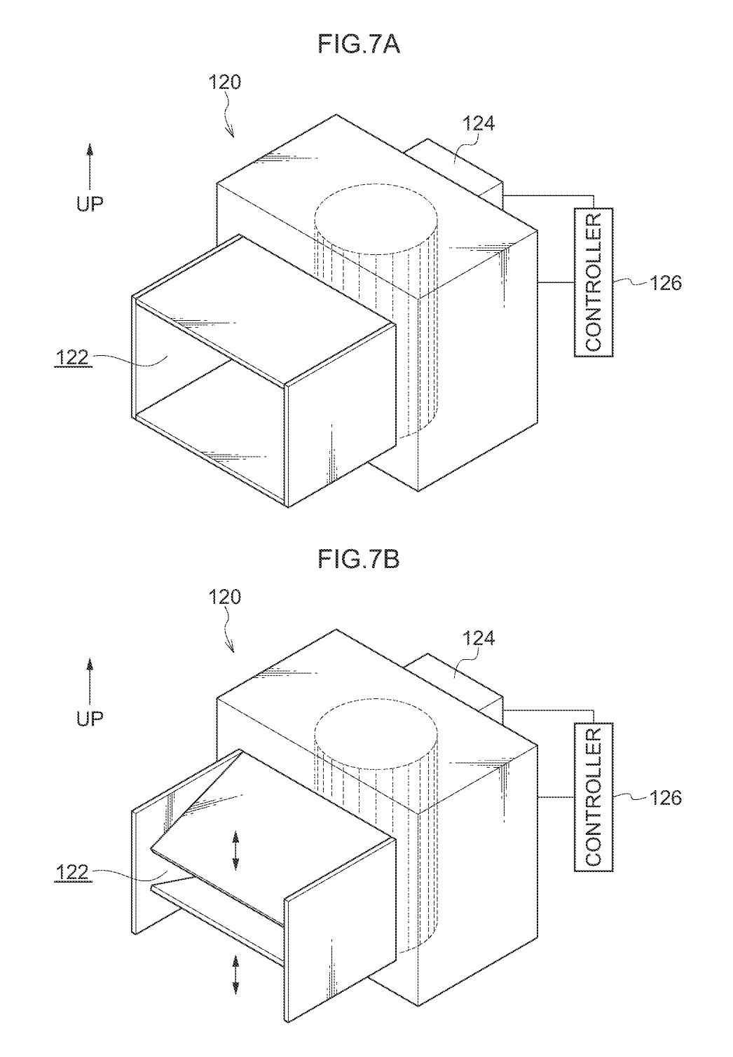

A seasoning device and an image forming apparatus 10 according to a second embodiment of the invention will be described below with reference to FIGS. 7A and 7B. Arrow UP in the drawings represents the upside in the vertical direction. The same elements as the first embodiment are referenced by the same reference numerals and signs and description thereof is omitted.

As shown in FIGS. 7A and 7B, an air blower 120 is a sirocco fan (for example, a sirocco fan SAN ACE B97 (9BMB24P2K01) made by SANYO DENKI CO., LTD.) and the air pressure of the blower 120 is set to a static pressure which is equal to or greater than 500 Pa. The air nozzle (air blowing opening) of the air blower 120 employs a variable air nozzle 122 of which the opening area is variable by changing the opening height.

A second controller 126 is provided which controls the air blower 120 and a moving member 124. The second controller 126 sets the air pressure of the air blower 120 when the air is blown to the lower side end portion of the sheet bundle 64 to be higher than the air pressure of the air blower 120 when the air is blown to the upper side end portion of the sheet bundle 64. Specifically, the opening height of the variable air nozzle 122 is changed to change the air pressure.

The second controller 126 controls the moving member 124 to set the moving speed of which the position at which the air is blown is moved in the up and down direction so that the moving speed of the position at the lower side is lower than the moving speed of the position at the upper side.

As described above, by setting the air pressure of the air blower 120 when the air is blown to the lower side end portion of the sheet bundle 64 to be larger than the air pressure of the air blower 120 when the air is blown to the upper side end portion of the sheet bundle 64, it is possible to efficiently blow air to the lower side sheets of paper P on which the weight of the upper side sheets of paper P is loaded, thereby effectively adapting the sheet bundle 64 to the surrounding environment.

By setting the moving speed of which the position at which the air is blown is moved in the up and down direction so that the moving speed in the downside is lower than the moving speed in the upside, it is possible to efficiently blow air to the lower side sheets of paper on which the weight of the upper side sheets of paper P is loaded, thereby further effectively adapting the sheet bundle to the surrounding environment.

By setting the air pressure of the air blower 120 to a static pressure equal to or greater than 500 Pa, it is possible to satisfactorily acquire a high air blowing efficiency with overcoming the pressure loss between the sheets of paper P.

While the specific embodiments of the invention have been described in detail, the invention is not limited to the embodiments, but it will be apparent to those skilled in the art that the invention can be modified in various forms within the scope of the invention. For example, in the above-mentioned embodiments, the sheet plane of the sheet end portion in the air blowing direction is regulated to be parallel to the air blowing direction even when the curl of the sheets of paper P is strong, by curving the lower separation plate 66B in a convex shape toward upper side as viewed in the air blowing direction. However, by curving the lower separation plate in a concave shape (convex shape toward lower side) as viewed in the air blowing direction (that is, in a state such that the lower separation plate 66B in FIG. 2 is curved in a convex shape toward lower side), it is possible to regulate the sheet plane of the sheet end portion in the air blowing direction to be parallel to the air blowing direction even when the curl of the sheets of paper is strong, thereby stabilizing the ventilation between sheets of paper P.

Although it has been described in the above-mentioned embodiments that the air blowers 104 and 120 are moved vertically to move the position at which the air is blown to the end portion of the sheet bundle 64 in the up and down direction, the position at which the air is blown may be moved in the up and down direction by vertically swinging the air nozzle of the air blower.

The above-mentioned embodiments can be properly combined without departing from the concept of the present invention.

What is claimed is:

1. An image forming apparatus comprising:
an image forming apparatus main body that ejects ink droplets onto a sheet of paper to form an image; and
a seasoning device that is disposed in a discharge unit to which the sheet of paper having an image formed thereon by the image forming apparatus main body is discharged,
wherein the seasoning device includes
a separation section that separates stacked sheets of paper on which images are formed into a sheet bundle,
an air blowing member that blows air toward an end portion of the sheet bundle separated by the separation section, and
a moving member that moves a position at which the air is blown to the end portion of the sheet bundle by the air blowing member in an up and down direction in which the sheets of paper are stacked.

2. The image forming apparatus of claim 1, further comprising a first controller that controls an air volume of the air blowing member,
wherein the first controller sets the air volume of the air blowing member when the air is blown toward the end portion at a lower side of the sheet bundle to be larger than the air volume of the air blowing member when the air is blown toward the end portion at an upper side of the sheet bundle.

3. The image forming apparatus of claim 1, further comprising a second controller that controls an air pressure of the air blowing member,
wherein the second controller sets the air pressure of the air blowing member when the air is blown toward the end portion at a lower side of the sheet bundle to be higher than the air pressure of the air blowing member when the air is blown toward the end portion at an upper side of the sheet bundle.

4. The image forming apparatus of claim 3, wherein
an air nozzle of the air blowing member is a variable air nozzle, of which an opening area is variable, and
the second controller changes the air pressure of the air nozzle by changing the opening area of the variable air nozzle.

5. The image forming apparatus of claim 3, wherein the second controller controls the moving member such that a moving speed at which the position at which the air is blown is moved in the up and down direction is set so that the moving speed, at a time when the position is moving on the end portion at the lower side of the sheet bundle, is slower than the moving speed, at a time when the position is moving on the end portion at the upper side of the sheet bundle.

6. The image forming apparatus of claim 4, wherein the second controller controls the moving member such that a moving speed at which the position at which the air is blown is moved in the up and down direction is set so that the moving speed, at a time when the position is moving on the end portion at the lower side of the sheet bundle, is slower than the moving speed, at a time when the position is moving on the end portion at the upper side of the sheet bundle.

7. The image forming apparatus of claim 2, further comprising a temperature and humidity adjusting unit that adjusts temperature and humidity,
wherein the air blowing member blows normal-temperature and normal-humidity air adjusted by the temperature and humidity adjusting unit to the end portion of the sheet bundle.

8. The image forming apparatus of claim 3, further comprising a temperature and humidity adjusting unit that adjusts temperature and humidity,
wherein the air blowing member blows normal-temperature and normal-humidity air adjusted by the temperature and humidity adjusting unit to the end portion of the sheet bundle.

9. The image forming apparatus of claim 3, wherein the air pressure of the air blowing member is set to a static pressure which is equal to or greater than 500 Pa.

10. The image forming apparatus of claim 2, wherein the separation section is curved in a convex shape toward the upper side as viewed from an air blowing direction of the air blowing member.

11. The image forming apparatus of claim 3, wherein the separation section is curved in a convex shape toward the upper side as viewed from an air blowing direction of the air blowing member.

12. The image forming apparatus of claim 2, wherein the separation section is curved in a convex shape toward the lower side as viewed from an air blowing direction of the air blowing member.

13. The image forming apparatus of claim 3, wherein the separation section is curved in a convex shape toward the lower side as viewed from an air blowing direction of the air blowing member.
